(19) United States
(12) Patent Application Publication
(10) Pub. No.: US 2004/0093594 A1
(43) Pub. Date: May 13, 2004

(54) System and process for developing and maintaining software applications for a business organization

(76) Inventors: Viren Kapadia, American Canyon, CA (US); Byron Tatsumi, Concord, CA (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/292,737

(22) Filed: Nov. 13, 2002

(51) Int. Cl. H04N 7/173; G06F 9/44; G06F 17/60; H04L 9/00; H04K 1/00; G06F 13/00; H04N 5/445

(52) U.S. Cl. 717/170; 705/59; 725/132; 725/50

(57) ABSTRACT

The present invention relates to a system and process for facilitating consistent calculation and attribution of cost savings within an organization. More specifically, the present invention relates to a system and process for guiding a user through a series of determinations related to various cost savings for attributing the cost savings to specific classifications and calculating the cost savings.

### BACKGROUND OF THE INVENTION

The present invention relates to a system and process for developing and maintaining applications for business organizations, and more particularly, to a system and process for developing, maintaining and updating a plurality of reporting applications used by one or more divisions within a business organization.

Organizations use many types of software applications (referred to as “applications”), such as reporting applications, data processing applications, and similar applications. Often, in organizations that comprise a number of different departments and/or divisions, different applications or versions of applications will be used in different departments or divisions.

Further, some departments or divisions may use some of the same applications, but not other applications. By way of example, two division may use the same reporting application, while the first division uses a particular data processing application while the second division may not use an data processing application. Further, different divisions or departments may use different versions of the same application and/or completely different types of a particular application.

Differences in application usage within an organization may complicate efforts to improve performance within the organization. If a new version of an application is acquired, it may be necessary to update the application in all of the divisions or departments that use the application. Further, to maintain compatibility and to ensure that departments and divisions can communication, it may be necessary to ensure that the software applications are updated at the same time. Such efforts may be complicated by customized portions of an application within a division or department. For example, a payroll department may have certain customized portions of a data processing application that differs from that used in a an audit department.

An additional drawback may include ensuring that appropriate licenses and permissions have been obtained for an application. Based on whether a department or division is using an application under a site license, a per-user license, or other arrangement, updating and maintenance of an application may require an updated license for using the application. Failure to properly update the license may result in a breach of the license agreement, penalties and/or litigation costs.

Other drawbacks may also exist.

### SUMMARY OF THE INVENTION

An aspect of the present invention is to provide a system and process for consistent and standardized calculations of cost savings.

In an exemplary embodiment of the invention provides, a process for developing, testing, and operating reporting applications used by a plurality of entities within a business provides the steps of distributing end-user licenses to at least one of the plurality of entities, controlling a service level configuration for each of the plurality of entities, monitoring at least one application characteristic of each of the plurality of entities, alerting at least one entity of an issue of a reporting application based on a monitored at least one application characteristic, resolving the issue, upgrading and maintaining the reporting application based on the resolution of the issue, and allocating costs associated with resolving the issue and upgrading and maintaining the reporting application, where the costs are allocated among the plurality of entities.

By way of another exemplary embodiment, a medium containing code for causing a process to develop, test, and operate reporting applications used by a plurality of entities within a business provides code for distributing end-user licenses to at least one of the plurality of entities, code for controlling a service level configuration for each of the plurality of entities, code for monitoring at least one application characteristic of each of the plurality of entities, code for alerting at least one entity of an issue of a reporting application based on a monitored at least one application characteristic, code for resolving the issue, code for upgrading and maintaining the reporting application based on the resolution of the issue, and code for allocating costs associated with resolving the issue and upgrading and maintaining the reporting application, where the costs are allocated among the plurality of entities.

Further, a exemplary system for developing, testing, and operating reporting applications used by a plurality of entities within a business is provided, where the system includes means for distributing end-user licenses to at least one of the plurality of entities, means for controlling a service level configuration for each of the plurality of entities, means for monitoring at least one application characteristic of each of the plurality of entities, means for alerting at least one entity of an issue of a reporting application based on a monitored at least one application characteristic, means for resolving the issue, means for upgrading and maintaining the reporting application based on the resolution of the issue, and means for allocating costs associated with resolving the issue and upgrading and maintaining the reporting application, where the costs are allocated among the plurality of entities.

In addition, an exemplary embodiment includes a system for developing, testing, and operating reporting applications used by a plurality of entities within a business, where the system provides a distribution module which distributes end-user licenses to at least one of the plurality of entities, a controller module which controls a service level configuration for each of the plurality of entities, a monitor module which monitors at least one application characteristic of each of the plurality of entities, an alert module which alerts at least one entity of an issue of a reporting application based on a monitored at least one application characteristic, a resolution module which resolves the issue, an upgrade module which upgrades and maintains the reporting application based on the resolution of the issue, and an allocation module which allocates costs associated with resolving the issue and upgrading and maintaining the reporting application, where the costs are allocated among the plurality of entities.

Other advantages and exemplary embodiments are also included in the present application

### BRIEF DESCRIPTION OF THE FIGURES

FIG. 1 is a flowchart illustrating a control and approval process according to an embodiment of the present invention.

FIG. 2 is a flowchart illustrating a distribution of licenses according to an embodiment of the invention.

FIG. 3 is a flowchart illustrating a process for controlling configurations according to an embodiment of the invention.

FIG. 4 is a flowchart illustrating a process for alerting and monitoring according to an embodiment of the invention.

FIG. 5 is a flowchart illustrating a process for resolving issues according to an embodiment of the invention.

FIG. 6 is a flowchart illustrating a process for upgrading and maintenance according to an embodiment of the invention.

FIG. 7 is a flowchart illustrating a process for allocating costs according to an embodiment of the invention.

FIG. 8 is a schematic diagram of a system for developing and maintaining applications according to an embodiment of the invention.

FIG. 9 is an operational diagram of a system for developing and maintaining applications according to an embodiment.

### DETAILED DESCRIPTION OF THE INVENTION

Reference will now be made in detail to the present preferred embodiments of the invention, examples of which are illustrated in the accompanying drawings in which like reference characters refer to corresponding elements.

The present invention is related to a consistent and decentralized process for control and approval of various systems and process environments. Reference will be made to a reporting application technology environments and a customized hosting environment. More specifically, reference will be made to one organization, comprising several different entities, which has implemented the present invention in such an environment. However, it is understood that the present invention may be used in other technology environments

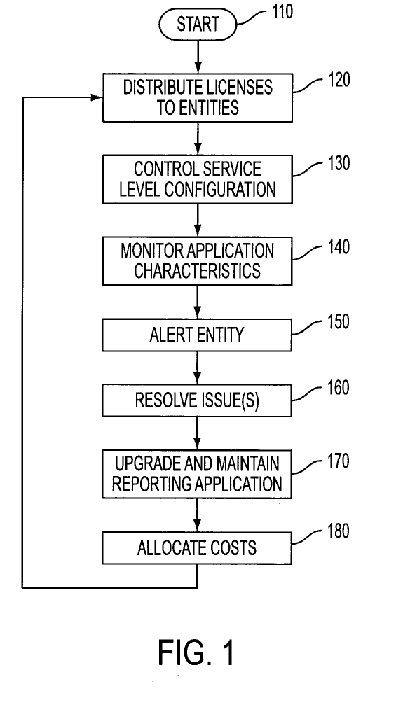

FIG. 1 is a flowchart illustrating a control and approval process according to an embodiment of the present invention. At step 110, the process begins. Beginning the process may comprise implementing the process and system on an organization-wide basis. At step 120, appropriate licenses are distributed to various entities within the organization. In the present example, software and licenses may be distributed, such as server software for hosting and a reporting application software, as well as any applicable licenses needed need to run the software. At step 130, a service level configuration is controlled. At step 140, application characteristics are monitored. In this example, characteristics of the reporting application may be monitored. An appropriate entity is alerted to any issues raised in the application at step 150. at step 160, the issues is resolved. At step 170, the application is maintained and upgraded. Costs associated with the process are allocated at step 180. The process may then return to step 120 to distribute more licenses as necessary. The process of FIG. 1 will now be described in greater detail below, with reference to additional figures as necessary.

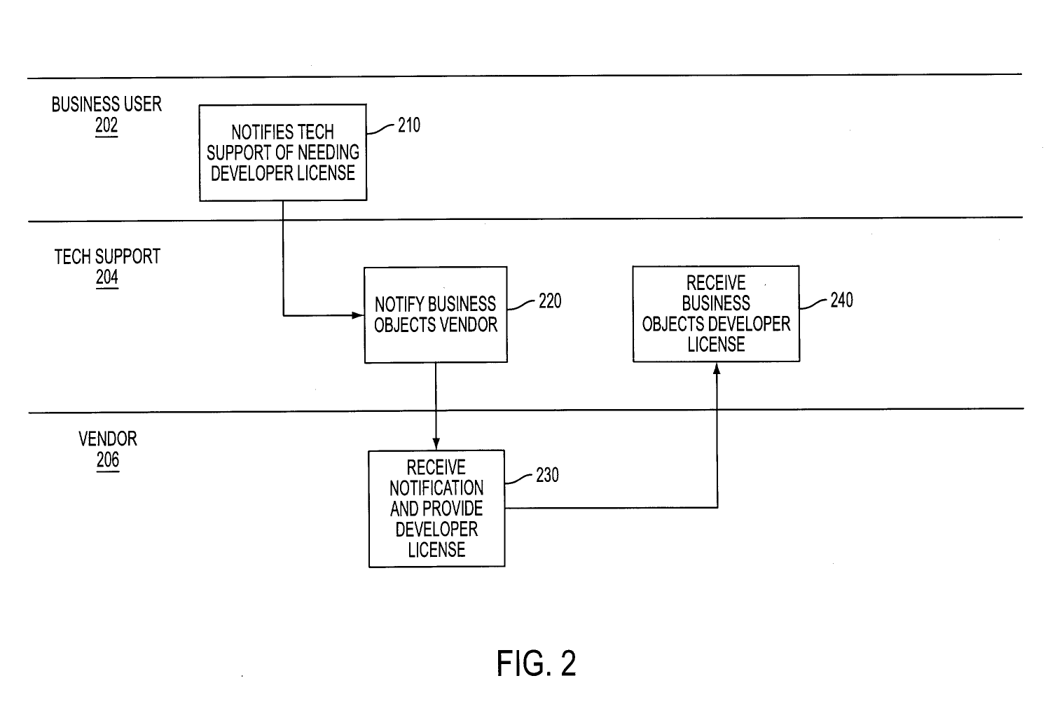

As described above, appropriate licenses are distributed to various entities within the organization at step 120. In the present example, software and licenses may be distributed, such as server software for hosting and a reporting application software, as well as any applicable licenses needed need to run the software. FIG. 2 illustrates a process for distribution of licenses according to an embodiment of the invention. For purposes of this illustration, the steps of the process are divided based on the entity performing the step. Thus, at level 202, the user is performing the step, while the technology support is performing the steps at level 204 and the vendor is performing the step at level 206. However, it is understood that particular steps may be performed other entities.

At step 210, a business user notifies technology support (also referred to “tech support”) that a license is needed. In this particular example, the business user needs a developer license for a particular software. At step 220, tech support notifies a vendor. The vendor receives the notification and provides the appropriate license at step 230, in this case a developer license. Tech support receives the developer license at step 240.

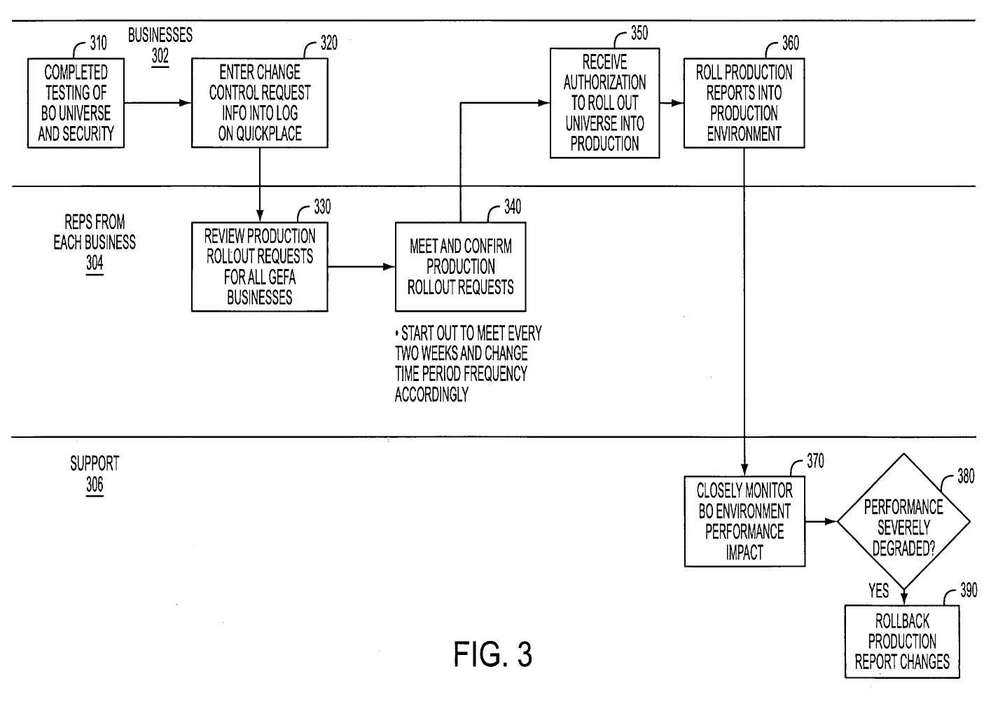

As described above at step 130, a service level configuration is controlled. FIG. 3 illustrates a process for controlling configurations according to an embodiment of the invention. As with FIG. 2, for purposes of this illustration, the steps of the process are divided based on the entity performing the step. Thus, at level 302, the user is performing the steps, while the entity representatives are performing the steps at level 304 and the support is performing the steps at level 306. However, it is understood that particular steps may be performed by other entities.

At step 310, testing of the universe is performed. According to an embodiment of the invention, a business user may test all portions of an organization that use the present invention. Testing may include testing for security, testing for errors, determining response from an application used by a plurality of entities, or other types of testing. At step 320, the user enters a request to change configuration controls. According to an embodiment, a request may contain information related to the change, such as, for example, the type of report(s) or changes, the name of the owner (e.g., the responsible person) of the report, the owner's contact information, the estimated impact of the change to one or more business entities, the urgency of the change, the change date requested and other information, and may logged at a central repository for consideration and action.

At step 330, requests for change configuration controls are reviewed. According to an embodiment of the invention, all requests to change configuration controls for all entities within an organization may be performed at generally the same time, thereby increasing efficiency. Representatives of the business unit receiving the request may review the request, as well as team leader of the business unit. Requests may be evaluated based on impact of the change, the resources necessary to implement the change, the effort required to start change, and other considerations. At step 340, representatives from various entities within the organization meet and confirm the production rollout of a request. According to an embodiment of the invention, the meeting may ensure that similar production rollouts are performed around the same time, collaborate on production rollouts involving similar hardware and/or software, or ensure that production rollouts are appropriately timed to avoid misconfiguration. According to an embodiment of the invention, entities may meet and confirm at predetermined time periods (e.g., every two weeks).

Authorization to rollout production into the universe occurs at step 350. In the example illustrated in FIG. 3, the user receives the authorization. At step 360, the changes are rolled in the universe. According to an embodiment of the invention, a user may coordinate a production rollout to minimize conflict with other applications and systems, and reduce inefficiencies. Other process may also be used.

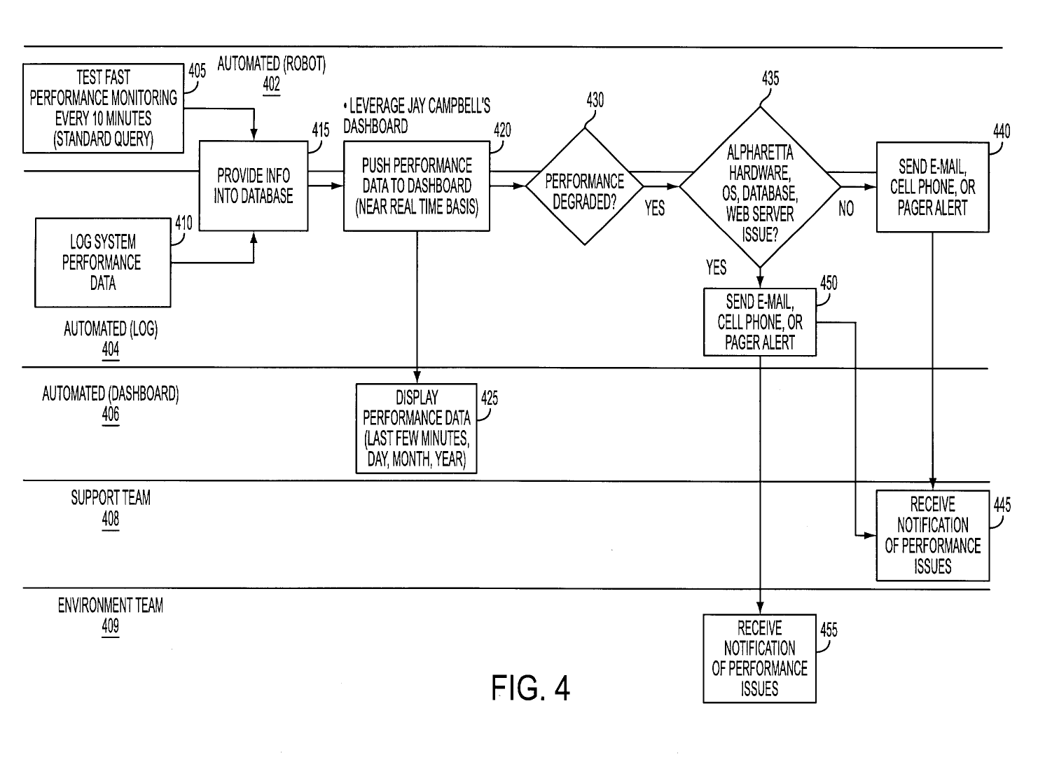

As described in step 140, application characteristics are monitored. FIG. 4 illustrates a process for alerting and monitoring according to an embodiment of the invention. Steps in level 402 may be performed automatically, such as by a robot log, while, level 404 is performed by an automated log, level 406 by an automated dashboard or display, at level 408 by a support team and level 409 by a team. However, it is understood that particular steps may be performed by other entities as well. In this example, characteristics of the reporting application may be monitored. At step 405, monitoring is tested at predetermined time interval. According to an embodiment of the invention, the testing may be automatically and may occur at ten minute intervals. Other time intervals may also be used. Further, testing may be performed manually. According to an embodiment of the invention, monitoring may include ensuring that the wing-to-wing cycle time of accessing information from the system is provided in an appropriate amount of time, as may be determined relative to services levels identified and customer expectations. At step 410, system performance data is recorded in a log. According to an embodiment of the invention, logging data may be performed automatically. Testing information and the logged data are entered into a database at step 415.

At step 420, performance data is pushed to a display, such as a dashboard. The performance data is then displayed at step 425. According to an embodiment of the invention, the data may be pushed and displayed on a near real time basis. Data displayed may also include past performance data, such as performance data within the last hour, day, week, year, etc., to enable a comparison of past and present performance.

At step 430, a determination is made whether performance has degraded. According to an embodiment of the invention, degradation may be based on a pre-selected performance level. Once selected, current performance may then be compared to the pre-selected level to determine if performance has degraded sufficiently to warrant action. If performance has degraded, a determination is made as to what portion of the system is causing the degradation at step 435. The determination may include examining specific hardware, operating systems, databases, web servers and other portions of a system. If the cause of the degradation cannot be determined, an alert is sent at step 440. The alert may comprise an e-mail message, a pager message, a cell phone message, a telephone message or other type of alert. According to an embodiment of the invention, performance monitoring and alerting software may include using QA Run and BMC Patrol software. At step 445, the alert is received by one or more technical support staff members.

If the cause of the degradation is determined, an alert is sent at step 450. The alert may comprise an e-mail message, a pager message, a cell phone message, a telephone message or other type of alert. The process moves to step 445, where the alert is received by one or more technical support staff members. Further, at step 455, the alert is received by a team associated with the problem. For example, if a web server is the source of the degradation, a team responsible for web servers is notified. Other process may also be used.

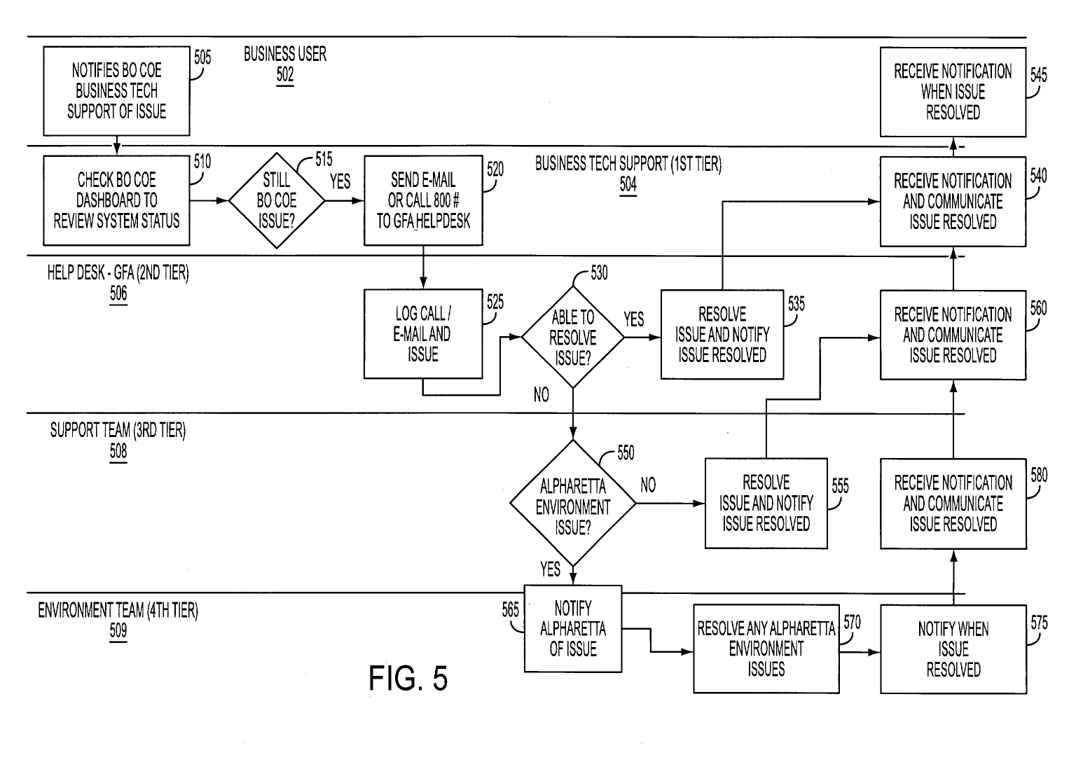

As described previously, an appropriate entity is alerted to any issues raised in the application at step 150. At step 160, the issues is resolved. FIG. 5 illustrates a process for resolving issues according to an embodiment of the invention. According to an embodiment of the invention, entities responsible for solving issues may categorized at a plurality of tiers. First tier entities may handle small issues, with additional tiers of entities handling issues of greater seriousness. In the example of FIG. 5, four tiers are provided, with tier one support handling minor, day-to-day issues, and tier four support handling the most serious issues. Other categorizations and responsibility assignments may also be used. In the example illustrated in FIG. 5, steps in level 502 are performed by a business user, steps at level 504 are performed by a technical support team, steps at level 506 are performed by a help desk, steps at level 508 are performed by a support team and steps at level 509 are performed by Alpharetta. However, it is understood that particular steps may be performed by other entities as well. At step 505, a department or division notify one or more technical support personnel, such as business technical support personnel, that an issue has arisen. At step 510, the one or more technical support members analyzes the displayed data. According to an embodiment, the one or more technical support members view the dashboard to review the system status. The one or more technical support members determine if the issue is still present at step 515. If not, no further action is taken.

If the issue remains, a request for assistance is sent to a help desk at step 520. The request may be in the form of an e-mail message, a telephone call, a cell phone call, a page, or other form. The request is logged at step 525 and a determination is made by the help desk whether it is able to resolve the issue at step 530. If the issue can be resolved, the help desk resolves the issue and sends notification regarding the resolution at step 535. According to an embodiment of the invention, notification may comprise an e-mail message, a pager message, a cell phone message, a telephone message or other type of notification. At step 540, the one or more technical support members are notified that the issue has been resolved and the division or department is then notified about the resolution from the one or more technical support members at step 545.

If at step 530, the help desk is unable to resolve the issue, a support team determines if the issue is an Alpharetta environment issue at step 550. According to an embodiment of the invention, an environment issue may involve elements of a system at a particular location. By way of example, physical hardware (e.g., servers), application software and web server software may reside at a location remote from a support team. This, if there is an operating system or hardware related issue, one or more technical representatives would be in charge of resolving the issue. If it is not an environment issue, the support team resolves the issue and notifies the help desk at step 555. According to an embodiment of the invention, notification may comprise an e-mail message, a pager message, a cell phone message, a telephone message or other type of notification. At step 560, the help desk receives the notification and communicates the issue resolution with the one or more technical support members. At step 540, the one or more technical support members are notified that the issue has been resolved and the division or department is then notified about the resolution from the one or more technical support members at step 545.

If it is an environment issue, the support team notifies at step 565, and the issue is resolved at step 570. The support team is notified at step 575. According to an embodiment of the invention, notification may comprise an e-mail message, a pager message, a cell phone message, a telephone message or other type of notification. The support team receives the notification and communicates that the issue is resolved at step 580. At step 560, the help desk receives the communication and communicates the issue resolution with the one or more technical support members. At step 540, the one or more technical support members are notified that the issue has been resolved and the division or department is then notified about the resolution from the one or more technical support members at step 545. According to an embodiment of the invention, communication may comprise an e-mail message, a pager message, a cell phone message, a telephone message or other type of communication. Other process may also be used.

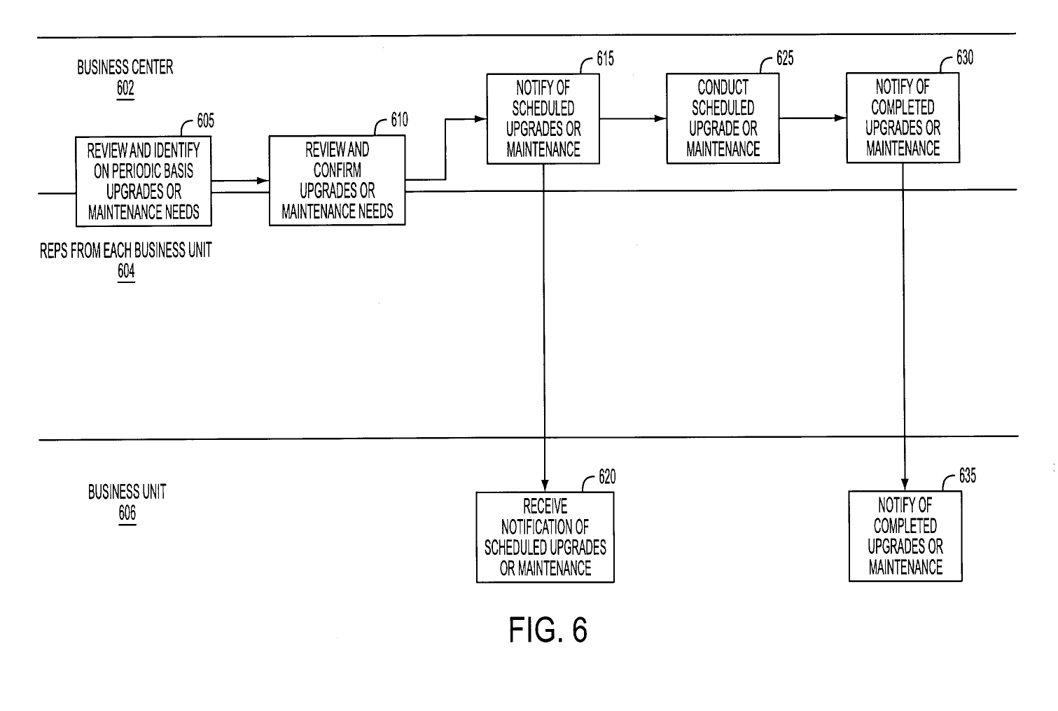

As described previously, at step 170, the application is maintained and upgraded. FIG. 6 illustrates a process for upgrading and maintenance according to an embodiment of the invention. In the example of FIG. 6, steps at level 602 are performed by a central business unit, steps at level 604 are performed by representatives from business units and steps at level 606 are performed by the business units. However, it is understood that particular steps may be performed by other entities, as well. At step 605, upgrade and maintenance needs are reviewed and identified. According to an embodiment of the invention, upgrade and maintenance needs are reviewed on a periodic basis and a business unit and/or its customers and users may identify what needs to be done. For example, upgrades and maintenance needs for an application may be reviewed monthly or quarterly. At step 610, confirmation of upgrade and maintenance needs is performed. According to an embodiment of the invention, a business unit and/or its customers and users may sign-off on an upgrade or maintenance. At step 615, notification of scheduled upgrades and maintenance is sent. According to an embodiment of the invention, notification is provided to the division or department which uses the application which is being upgraded or maintained. Other interested businesses or personnel may also receive the notification. Further, it is understood that a notification may comprise an e-mail message, a pager message, a cell phone message, a telephone message or other type of notification.

At step 620, the notification of the scheduled upgrade and maintenance is received. At step 625, the scheduled upgrade and maintenance is conducted. A notification of the completion of the scheduled upgrade and maintenance is sent at step 630. According to an embodiment of the invention, notification is provided to the same divisions, departments, and other interested businesses and personnel which received the notification that the scheduled upgrade and/or maintenance is to begin. Further, it is understood that a notification may comprise an e-mail message, a pager message, a cell phone message, a telephone message or other type of notification. At step 635, the notification of the scheduled upgrade and maintenance is received. Other process may also be used.

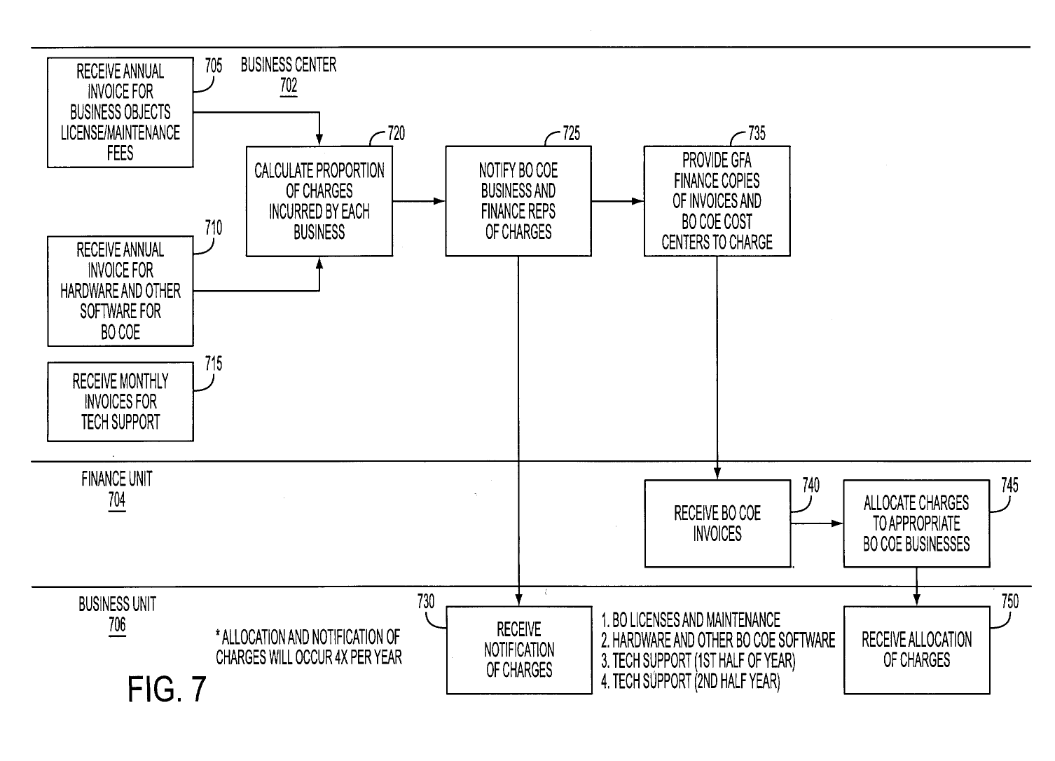

Costs associated with the process are allocated at step 180. FIG. 7 illustrates a process for allocating costs according to an embodiment of the invention. In the example of FIG. 7, steps at level 702 are performed by a central business unit, steps at level 704 are performed by a finance unit, and steps at level 706 are performed at various departments and divisions. However, it is understood that particular steps may be performed by other entities. At step 705, an invoice is received at a business center for license and maintenance fees. At step 710, an invoice is received at the business center for hardware and software costs, licenses and maintenance fees. At step 715, an invoice is received at the business center for technical support fees and costs. According to an embodiment of the invention, the invoice may be sent on a periodic basis, such as monthly, quarterly, or annually.

At step 720, the business center calculates the proportion of charges incurred by each division, department or other business organization unit. According to an embodiment of the invention, the calculation of charges may be based on the received invoices. At step 725, the business center notifies the divisions, departments and other business organization units about the charges. According to an embodiment of the invention, a representative, such as a financial representative, of each division, department and other business organization unit receives the notification. At step 730, the divisions, departments and other business organization units receive the notification about the charges. According to an embodiment of the invention, receipt of the notification may enable the divisions, departments and other business organization units to question charges. At step 735, copies of invoices and cost are provided for charging to the various divisions, departments and other business organization units.

At step 740, the invoices are received for charging to the various divisions, departments and other business organization units. According to an embodiment of the invention, a financial department or division of the business organization may be responsible for charging the other various divisions, departments and other business organization units. At step 745, the charges are allocated to the appropriate divisions, departments and other business organization units. At step 750, the various divisions, departments and other business organization units receive the allocated charges.

The present invention provides a service model for customers to receive a customized service environment which is designed for a specific reporting application. This model may reduce expense and effort associated with duplicate efforts at various departments, divisions and/or other business entities. Further, decentralized execution may ensure that each business who uses the services may work independently with minimal centralized control and/or approvals in its environment. A configuration control process for an application environment may ensure that all entities receive appropriate service levels based on the applications they are developing, testing, and/or running in production. An application provider may support processes such as licenses, distribution, configuration control, performance monitoring, issue resolution, technology support, environment maintenance and upgrades and cost allocation.

Further, the present invention may provide standardization of environments, such as a reporting application technology environment. Business intelligence and solutions may be accessed, analyzed and shared across an organization. Further, information technology departments may be provided with the necessary tools to setup, control and manage user access.

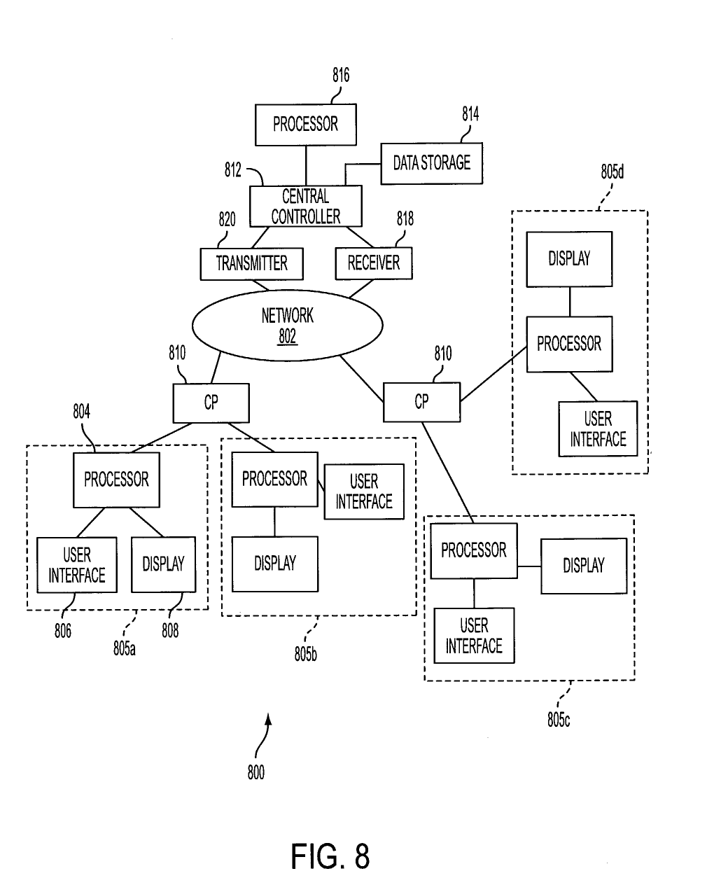

FIG. 8 illustrates a system 800 according to an embodiment of the present invention. The system 800 comprises a plurality of computer devices 805 (or “computers”) used by a plurality of users to connect to a network 802 through a plurality of connection providers (CPs) 810. The network 802 may be any network that permits multiple computers to connect and interact. According to an embodiment of the invention, the network 802 may be comprised of a dedicated line to connect the plurality of the users, such as the Internet, an intranet, a local area network (LAN), a wide area network (WAN), a wireless network, or other type of network. Each of the CPs 810 may be a provider that connects the users to the network 802. For example, the CP 810 may be an Internet service provider (ISP), a dial-up access means, such as a modem, or other manner of connecting to the network 802. In actual practice, there may be significantly more users connected to the system 800 than shown in FIG. 8. This would mean that there would be additional users who are connected through the same CPs 810 shown or through another CP 810. Nevertheless, for purposes of illustration, the discussion will presume three computer devices 805-805d are connected to the network 802 through two CPs 810.

According to an embodiment of the invention, the computer devices 805a-805d may each make use of any device (e.g., a computer, a wireless telephone, a personal digital assistant, etc.) capable of accessing the network 802 through the CP 810. Alternatively, some or all of the computer devices 805a-805d may access the network 802 through a direct connection, such as a T1 line, or similar connection. FIG. 8 shows the three computer devices 805a-805c, each having a connection to the network 802 through the CP 810a and the CP 810b. The computer devices 805a-805d may each make use of a personal computer such as a computer located in a user's home, or may use other devices which allow the user to access and interact with others on the network 802. A central controller module 812 may also have a connection to the network 802 as described above. The central controller module 812 may communicate with one or more modules, such as one or more data storage modules 814, one or more processor modules 816, or other modules.

Each of the computer devices 805a-805d used may contain a processor module 804, a display module 808, and a user interface module 806. Each of the computer devices 805a-805d may have at least one user interface module 806 for interacting and controlling the computer. The user interface module 806 may be comprised of one or more of a keyboard, a joystick, a touchpad, a mouse, a scanner or any similar device or combination of devices. Each of the computers 805a-805d may also include a display module 808, such as a CRT display or other device. According to an embodiment of the invention, a developer, a user of a production system, and/or a change management module may use a computer device 805.

The central controller module 812 may maintain a connection to the network 802 such as through a transmitter module 820 and a receiver module 918. The transmitter module 820 and the receiver module 818 may be comprised of conventional devices that enable the central controller module 812 to interact with the network 802. According to an embodiment of the invention, the transmitter module 820 and the receiver module 818 may be integral with the central controller module 812. According to another embodiment of the invention, the transmitter module 820 and the receiver module 818 may be portions of one connection device. The connection to the network 802 by the central controller module 812 and the computer devices 805 may be a high speed, large bandwidth connection, such as through a T1 or a T3 line, a cable connection, a telephone line connection, a DSL connection, or another similar type of connection. The central controller module 812 functions to permit the computer devices 805a-805c to interact with each other in connection with various applications, messaging services and other services which may be provided through the system 800.

The central controller module 812 preferably comprises either a single server computer or a plurality of server computers configured to appear to the computer devices 805a-805d as a single resource. The central controller module 812 communicates with a number of modules. Each module will now be described in greater detail.

A processor module 816 may be responsible for carrying out processing within the system 800. According to an embodiment of the invention, the processor module 818 may handle high-level processing, and may comprise a math co-processor or other processing devices.

Data may be stored in a data storage module 814. The data storage module 814 stores a plurality of digital files. According to an embodiment of the invention, a plurality of data storage modules 814 may be used and located on one or more data storage devices, where the data storage devices are combined or separate from the controller module 812. One or more data storage modules 814 may also be used to archive information.

While the system 800 of FIG. 8 discloses the requester device 805 connected to the network 802, it should be understood that a personal digital assistant (“PDA”), a mobile telephone, a television, or another device that permits access to the network 802 may be used to arrive at the system of the present invention. It is understood that, while system 800 is represented in FIG. 8 as a network based system, other systems may also be used, with applicable modules resident therein. Other systems may also be used.

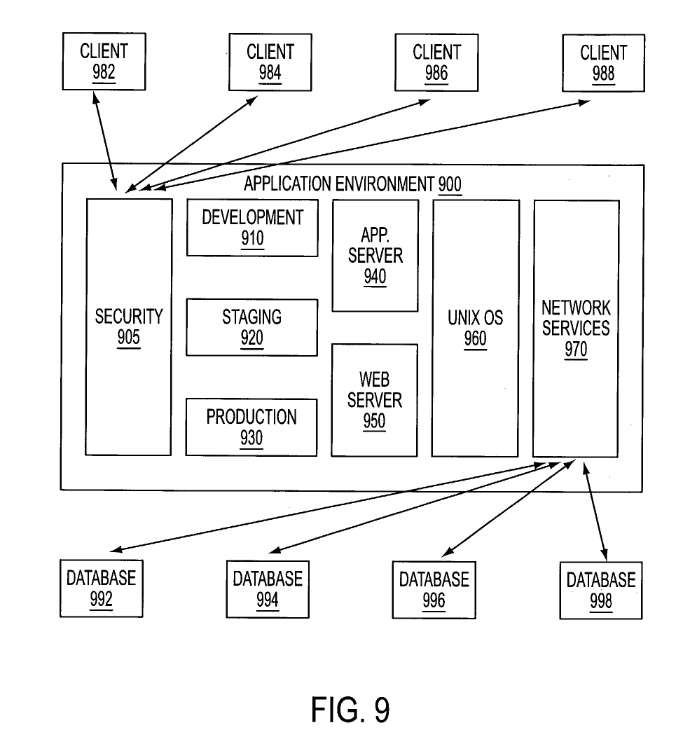

FIG. 9 illustrates a system for a business objects application environment. System 900 comprises a security module 905, development module 910, staging module 920, production module 930, application server 940, web server 950, operating system module 960, network services module 970 and data storage modules 990.

Security module 905 may provide a secure connection between system 900 and clients 982, 984, 986 and 988, such as a firewall or other security measures. According to an embodiment of the invention, clients 982, 984, 986 and 988 may be the various divisions, departments and other business units within the business organization. Clients 982, 984, 986 and 988 may be connected to system 900, such as through a network, to enable upgrades and maintenance to be performed.

Development module 910 provides the ability to develop upgrades and maintain existing applications. Staging module 920 provides a staging platform to send upgrades and maintenance to clients 982, 984, 986 and 988. Production module 930 provides the ability to place the upgrades and maintenance versions into production. According to an embodiment of the invention, each module may provide a separate environment based on the project lifecycle. A development module 910 may provide a stand alone, separate environment which may allow one or more developers to design and/or build an application. A staging module 920 may provide a stand alone, separate environment which may allow one or more users to test an application, including unit, integration, load and stress, and repression testing. A production module 930 may provide a stand alone, separate environment which may allow the completed and operationalized application to function or a real-time basis to one or more customers.

Application server 940 serves applications and their respective functions to clients 982, 984, 986 and 988. Web server 950 servers web pages, data, and other internet functions to clients 982, 984, 986 and 988. According to an embodiment of the invention, application server 940 and web server 950 may be a Sun E450 server. Further, a web server layer may be used, such as iPlanet. Operating system module 960 provides the operating system platform for running system 900 and enabling other functions and features to be performed as necessary. According to an embodiment of the invention, operating system module 960 may use a UNIX based operating system, such as Solaris.

Network services module 970 provides services related to network connections, such as to databases 992, 992, 996 and 998. According to an embodiment of the invention, databases 992, 994, 996 and 998 may use a Sun F6800 server running an Oracle database software.

According to another embodiment of the invention, a computer-usable and writeable medium having a plurality of computer readable program code stored therein may be provided for practicing the process of the present invention. The process and system of the present invention may be implemented within a variety of operating systems, such as a Windows® operating system, various versions of a Unix-based operating system (e.g., a Hewlett Packard, a Red Hat, or a Linux version of a Unix-based operating system), or various versions of an AS/400-based operating system. For example, the computer-usable and writeable medium may be comprised of a CD ROM, a floppy disk, a hard disk, or any other computer-usable medium. One or more of the components of a system may comprise computer readable program code in the form of functional instructions stored in the computer-usable medium such that when the computer-usable medium is installed on the system, those components cause the system to perform the functions described. The computer readable program code for the present invention may also be bundled with other computer readable program software.

According to one embodiment, the central controller module 812, the transmitter module 820, the receiver module 818, the processor module 816, data storage module 814, security module 905, development module 910, staging module 920, production module 930, application server 940, web server 950, operating system module 960, network services module 970 and data storage modules 990 may each comprise computer-readable code that, when installed on a computer, performs the functions described above. Also, only some of the components may be provided in computer-readable code.

Additionally, various entities and combinations of entities may employ a computer to implement the components performing the above-described functions. According to an embodiment of the invention, the computer may be a standard computer comprising an input device, an output device, a processor device, and a data storage device. According to other embodiments of the invention, various components may be computers in different departments within the same corporation or entity. Other computer configurations may also be used. According to another embodiment of the invention, various components may be separate entities such as corporations or limited liability companies. Other embodiments, in compliance with applicable laws and regulations, may also be used.

According to one specific embodiment of the present invention, the system may comprise components of a software system. The system may operate on a network and may be connected to other systems sharing a common database. Other hardware arrangements may also be provided.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

In the claims:

1. A process for developing, testing, and operating reporting applications used by a plurality of entities within a business comprising the steps of:
distributing end-user licenses to at least one of the plurality of entities;
controlling a service level configuration for each of the plurality of entities;
monitoring at least one application characteristic of each of the plurality of entities;
alerting at least one entity of an issue of a reporting application based on a monitored at least one application characteristic;
resolving the issue;
upgrading and maintaining the reporting application based on the resolution of the issue; and
allocating costs associated with resolving the issue and upgrading and maintaining the reporting application, where the costs are allocated among the plurality of entities.

2. The process according to claim 1, wherein the step of controlling a service level configuration for each of the plurality of entities further comprises:
receiving at least one change control request from one of the plurality of entities;
reviewing the at least one change control request; and
transmitting an approval of the at least one change control request.

3. The process according to claim 1, wherein the step of monitoring at least one application characteristic of each of the plurality of entities further comprises:
testing the performance of the reporting application at least one of the plurality of entities;
determining if the performance of the reporting application has degraded; and
notifying the at least one entity that performance has degraded.

4. The process according to claim 3, further comprising the step of storing the results of the performance testing, and
wherein the step of determining if the performance of the reporting application has degraded is based on a comparison of previous testing results.

5. The process according to claim 1, wherein the step of resolving the issue further comprises the steps of:
reviewing the status of the reporting application;
forward a request for resolution to a support entity; and
receiving a communication from the support entity, where the communication comprises one of:
a) indicating that the issue has been resolved; and
b) indicating that the issue has not been resolved.

6. The process according to claim 5, wherein upon receiving a communication indicating that the issue has not been resolved, further comprises the steps of:
forward a request for resolution to a second support entity; and
receiving a communication from the second support entity, where the communication comprises one of:
a) indicating that the issue has been resolved; and
b) indicating that the issue has not been resolved.

7. The process according to claim 1, wherein the step of upgrading and maintaining the reporting application based on the resolution of the issue further comprises:
reviewing and upgrading the reporting applications at each of the plurality of entities; and
reviewing and maintaining the reporting applications at each of the plurality of entities.

8. The process according to claim 7, wherein the step of reviewing upgrade needs further comprises:
reviewing upgrading needs for the reporting application of each of the plurality of entities;
generating a schedule for upgrading the reporting applications based on the upgrading needs;
performing the upgrading of the reporting applications; and
notifying each of the plurality of entities that the upgrade has been completed.

9. The process according to claim 7, wherein the step of reviewing maintenance needs further comprises:
reviewing maintenance needs for the reporting application of each of the plurality of entities;
generating a schedule for maintenance of the reporting applications based on the upgrading needs;
performing the maintenance of the reporting applications; and
notifying each of the plurality of entities that the maintenance has been completed.

10. The process according to claim 1, where the step of allocating costs further comprises the steps of:
receiving a report of costs associated with the reporting applications for each of the plurality of entities;
calculating the proportion of the costs for each of the plurality of entities; and
invoicing each of the plurality of entities based on the calculated proportion of costs.

11. A medium containing code for causing a process to develop, test, and operate reporting applications used by a plurality of entities within a business comprising:
code for distributing end-user licenses to at least one of the plurality of entities;
code for controlling a service level configuration for each of the plurality of entities;
code for monitoring at least one application characteristic of each of the plurality of entities;
code for alerting at least one entity of an issue of a reporting application based on a monitored at least one application characteristic;
code for resolving the issue;
code for upgrading and maintaining the reporting application based on the resolution of the issue; and
code for allocating costs associated with resolving the issue and upgrading and maintaining the reporting application, where the costs are allocated among the plurality of entities.

12. The code according to claim 11, wherein the code for controlling a service level configuration for each of the plurality of entities further comprises:
code for receiving at least one change control request from one of the plurality of entities;
code for reviewing the at least one change control request; and
code for transmitting an approval of the at least one change control request.

13. The code according to claim 11, wherein the code for monitoring at least one application characteristic of each of the plurality of entities further comprises:
code for testing the performance of the reporting application at least one of the plurality of entities;
code for determining if the performance of the reporting application has degraded; and
code for notifying the at least one entity that performance has degraded.

14. The code according to claim 13, further comprising code for storing the results of the performance testing, and
wherein the code for determining if the performance of the reporting application has degraded is based on a comparison of previous testing results.

15. The code according to claim 11, wherein the step of resolving the issue further comprises:
code for reviewing the status of the reporting application;
code for forward a request for resolution to a support entity; and
code for receiving a communication from the support entity, where the communication comprises one of:
a) indicating that the issue has been resolved; and
b) indicating that the issue has not been resolved.

16. The code according to claim 15, wherein upon receiving a communication indicating that the issue has not been resolved, further comprises:
code for forward a request for resolution to a second support entity; and
code for receiving a communication from the second support entity, where the communication comprises one of:
a) indicating that the issue has been resolved; and
b) indicating that the issue has not been resolved.

17. The code according to claim 11, wherein the code for upgrading and maintaining the reporting application based on the resolution of the issue further comprises:
code for reviewing and upgrading the reporting applications at each of the plurality of entities; and
code for reviewing and maintaining the reporting applications at each of the plurality of entities.

18. The code according to claim 17, wherein the code for reviewing upgrade needs further comprises:
code for reviewing upgrading needs for the reporting application of each of the plurality of entities;
code for generating a schedule for upgrading the reporting applications based on the upgrading needs;
code for performing the upgrading of the reporting applications; and
code for notifying each of the plurality of entities that the upgrade has been completed.

19. The code according to claim 17, wherein the code for reviewing maintenance needs further comprises:
code for reviewing maintenance needs for the reporting application of each of the plurality of entities;
code for generating a schedule for maintenance of the reporting applications based on the upgrading needs;
code for performing the maintenance of the reporting applications; and
code for notifying each of the plurality of entities that the maintenance has been completed.

20. The code according to claim 11, where the code for allocating costs further comprises:
code for receiving a report of costs associated with the reporting applications for each of the plurality of entities;
code for calculating the proportion of the costs for each of the plurality of entities; and
code for invoicing each of the plurality of entities based on the calculated proportion of costs.

21. A system for developing, testing, and operating reporting applications used by a plurality of entities within a business comprising:
means for distributing end-user licenses to at least one of the plurality of entities;
means for controlling a service level configuration for each of the plurality of entities;
means for monitoring at least one application characteristic of each of the plurality of entities;
means for alerting at least one entity of an issue of a reporting application based on a monitored at least one application characteristic;
means for resolving the issue;
means for upgrading and maintaining the reporting application based on the resolution of the issue; and
means for allocating costs associated with resolving the issue and upgrading and maintaining the reporting application, where the costs are allocated among the plurality of entities.

22. The system according to claim 21, wherein the means for controlling a service level configuration for each of the plurality of entities further comprises:
means for receiving at least one change control request from one of the plurality of entities;
means for reviewing the at least one change control request; and
means for transmitting an approval of the at least one change control request.

23. The system according to claim 21, wherein the means for monitoring at least one application characteristic of each of the plurality of entities further comprises:
means for testing the performance of the reporting application at least one of the plurality of entities;
means for determining if the performance of the reporting application has degraded; and
means for notifying the at least one entity that performance has degraded.

24. The system according to claim 23, further comprising means for storing the results of the performance testing, and
wherein the means for determining if the performance of the reporting application has degraded is based on a comparison of previous testing results.

25. The system according to claim 21, wherein the means for resolving the issue further comprises:
means for reviewing the status of the reporting application;
means for forward a request for resolution to a support entity; and
means for receiving a communication from the support entity, where the communication comprises one of:
a) indicating that the issue has been resolved; and
b) indicating that the issue has not been resolved.

26. The system according to claim 25, wherein upon receiving a communication indicating that the issue has not been resolved, further comprises:
means for forward a request for resolution to a second support entity; and
means for receiving a communication from the second support entity, where the communication comprises one of:
a) indicating that the issue has been resolved; and
b) indicating that the issue has not been resolved.

27. The system according to claim 21, wherein the means for upgrading and maintaining the reporting application based on the resolution of the issue further comprises:
means for reviewing and upgrading the reporting applications at each of the plurality of entities; and
means for reviewing and maintaining the reporting applications at each of the plurality of entities.

28. The system according to claim 27, wherein the means for reviewing upgrade needs further comprises:
means for reviewing upgrading needs for the reporting application of each of the plurality of entities;
means for generating a schedule for upgrading the reporting applications based on the upgrading needs;
means for performing the upgrading of the reporting applications; and
means for notifying each of the plurality of entities that the upgrade has been completed.

29. The system according to claim 27, wherein the means for reviewing maintenance needs further comprises:
means for reviewing maintenance needs for the reporting application of each of the plurality of entities;
means for generating a schedule for maintenance of the reporting applications based on the upgrading needs;
means for performing the maintenance of the reporting applications; and
means for notifying each of the plurality of entities that the maintenance has been completed.

30. The system according to claim 21, where the means for allocating costs further comprises:
means for receiving a report of costs associated with the reporting applications for each of the plurality of entities;
means for calculating the proportion of the costs for each of the plurality of entities; and
means for invoicing each of the plurality of entities based on the calculated proportion of costs.

31. A system for developing, testing, and operating reporting applications used by a plurality of entities within a business comprising:
a distribution module which distributes end-user licenses to at least one of the plurality of entities;
a controller module which controls a service level configuration for each of the plurality of entities;
a monitor module which monitors at least one application characteristic of each of the plurality of entities;
an alert module which alerts at least one entity of an issue of a reporting application based on a monitored at least one application characteristic;
a resolution module which resolves the issue;
an upgrade module which upgrades and maintains the reporting application based on the resolution of the issue; and
an allocation module which allocates costs associated with resolving the issue and upgrading and maintaining the reporting application, where the costs are allocated among the plurality of entities.

32. The system according to claim 31, wherein the control module further comprises:
a receiver which receives at least one change control request from one of the plurality of entities;
a review module which reviews the at least one change control request; and
a transmitter module which transmits an approval of the at least one change control request.

33. The system according to claim 31, wherein the monitor module further comprises:
a test module which tests the performance of the reporting application at least one of the plurality of entities;
an evaluation module which determines if the performance of the reporting application has degraded; and
a notification module which notifies the at least one entity that performance has degraded.

34. The system according to claim 33, further comprising a storage module which stores the results of the performance testing, and
wherein the determination module determines if the performance of the reporting application has degraded is based on a comparison of previous testing results.

35. The system according to claim 31, wherein the resolution module further comprises:
a review module which reviews the status of the reporting application;
a transmitter which forwards a request for resolution to a support entity; and
a receiver which receives a communication from the support entity, where the communication comprises one of:
a) indicating that the issue has been resolved; and
b) indicating that the issue has not been resolved.

36. The system according to claim 35, wherein:
the transmitter forwards a request for resolution to a second support entity; and
the receiver receives a communication from the second support entity, where the communication comprises one of:
a) indicating that the issue has been resolved; and
b) indicating that the issue has not been resolved.

37. The system according to claim 31, wherein the upgrading module further comprises:
a review module which:
reviews and upgrades the reporting applications at each of the plurality of entities; and
reviews and maintains the reporting applications at each of the plurality of entities.

38. The system according to claim 37, wherein the review module further:
reviews upgrading needs for the reporting application of each of the plurality of entities;
generates a schedule for upgrading the reporting applications based on the upgrading needs;
performs the upgrading of the reporting applications; and
notifies each of the plurality of entities that the upgrade has been completed.

39. The system according to claim 37, wherein the review module further:
reviews maintenance needs for the reporting application of each of the plurality of entities;
generates a schedule for maintenance of the reporting applications based on the upgrading needs;
performs the maintenance of the reporting applications; and
notifies each of the plurality of entities that the maintenance has been completed.

40. The system according to claim 31, where the allocation module further:
receives a report of costs associated with the reporting applications for each of the plurality of entities;
calculates the proportion of the costs for each of the plurality of entities; and
invoices each of the plurality of entities based on the calculated proportion of costs.
